(19) United States
(12) Patent Application Publication
(10) Pub. No.: US 2025/0225411 A1
(43) Pub. Date: Jul. 10, 2025

(54) Geosteering Copilot Assistant

(71) Applicant: Halliburton Energy Services, Inc., Houston, TX (US)

(72) Inventors: Edgar Gutierrez Gonzalez, Houston, TX (US); Jeremy James Combs, Houston, TX (US); David Franklin Anthony, Houston, TX (US)

(73) Assignee: Halliburton Energy Services, Inc., Houston, TX (US)

(21) Appl. No.: 18/405,960

(22) Filed: Jan. 5, 2024

(51) Int. Cl. G06N 5/04; E21B 7/04; E21B 47/024; E21B 49/00

(52) U.S. Cl. CPC G06N 5/04; E21B 7/04; E21B 47/024; E21B 49/00; E21B 2200/20

(57) ABSTRACT

A method and a system comprising: disposing a bottom hole assembly (BHA) into a wellbore, wherein the BHA comprises a measurement assembly; acquiring one or more measurements with the measurement assembly; acquiring historical data from the wellbore; extracting relevant information from the historical data; training a machine learning (ML) model with the relevant information to form a trained ML model; and providing an answer to a question utilizing the trained ML model.

### BACKGROUND

The oil and gas industry may use wellbores as fluid conduits to access subterranean deposits of various fluids and minerals which may include hydrocarbons. A Geosteeter are personnel that may perform a drilling operation to construct wellbores capable of producing hydrocarbons disposed in subterranean formations. Geosteerers may drill wellbores utilizing information such as historical data of the well or field of the well and downhole measurements. To illustrate, a geosteerers make a decision based on the information they have available. They will go into historical data and search for this information.

However, historical data may not be readily available. Often geosteerers work in a desert of information, not having all relevant information to make geosteering decisions. For example, historical data of a field may be slim or not reliable data. Therefore, geosteerers may be required to interpret downhole measurements with their knowledge and experience of geosteersing. Such knowledge and experience may be the nuggets of importance that if readily available may greatly improve the success of drilling decisions. Replicating knowledge and experience is a challenge because of the sheer quantity of data.

### BRIEF DESCRIPTION OF THE DRAWINGS

These drawings illustrate certain aspects of some examples of the present disclosure and should not be used to limit or define the disclosure.

FIG. 1 illustrates an example of a drilling system and operation;

FIG. 2 illustrates is a schematic view of an information handling system;

FIG. 3 illustrates another schematic view of and information handling system;

FIG. 4 illustrates a schematic view of a network;

FIG. 5 is a diagram of an example system with multiple information handling systems, connected via a network, and used to form computing resource pools;

FIG. 6 illustrates an artificial intelligence (AI) assistant co-pilot workflow; and

FIG. 7 illustrates an artificial co-pilot workflow.

### DETAILED DESCRIPTION

This disclosure details methods and systems which may utilize an artificial intelligence (AI) assistant engine to help geosteerers make geosteering decisions. As discussed below, historical data may be utilized by the AI assistant engine to create reports for geotseerers to review. Historical data may be an archive-based repository of reports from a field surrounding a wellbore in which current drilling operations may be ongoing. Each report may comprise data from a single wellbore within the field surrounding the drilling operations. Additionally, each report may be capable of answering questions about the field in which ongoing drilling operations are being performed. An AI assistant workflow may utilize any machine learning (ML) algorithm and may be trained with at least some historical data. An AI assistant may form correlations between downhole measurements and historical data utilizing one or more ML algorithms. Further, an AI assistant may generate a report of the current drilling environment and recommended decisions and operations to the geosteerer. As such, a geosteerer may utilize information received from AI assistant while forming geosteering decisions.

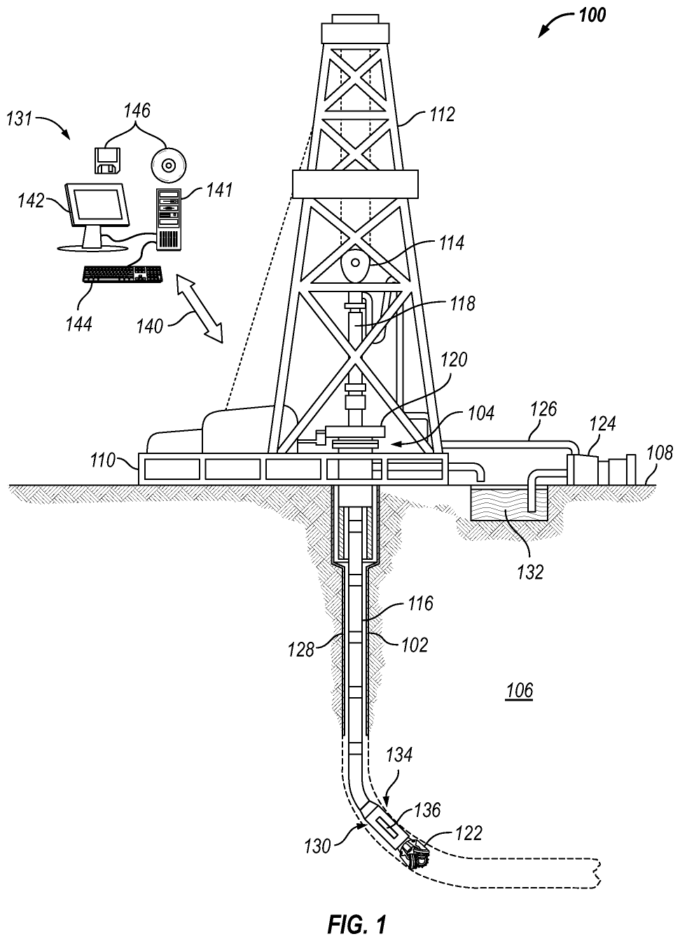

FIG. 1 illustrates an example of drilling system 100. The operations of drilling system 100 may be guided by a drilling program. In some examples, an initial drilling program may be generated prior to moving any drilling equipment to a wellsite location. In other examples, an initial drilling program may be generated prior to initiating a conductor borehole or a surface borehole. In further examples, the drilling program may be generated from a hybrid data generator which may further utilize a Large Language Model, physical models, empirical models, cost models, material supply models, and/or combinations thereof. As illustrated, wellbore 102 may extend from a wellhead 104 into a subterranean formation 106 from a surface 108. In some examples, wellbore 102 may be constructed based at least in part on a drilling program. Generally, wellbore 102 may include horizontal, vertical, slanted, curved, and other types of wellbore geometries and orientations. Wellbore 102 may be cased or uncased. In examples, wellbore 102 may include a metallic member. By way of example, the metallic member may be a casing, liner, tubing, or other elongated steel tubular disposed in wellbore 102.

As illustrated, wellbore 102 may extend through subterranean formation 106. As illustrated in FIG. 1, wellbore 102 may extend generally vertically into the subterranean formation 106, however, wellbore 102 may extend at an angle through subterranean formation 106, such as horizontal and slanted wellbores. It should further be noted that while FIG. 1 generally depicts land-based operations, those skilled in the art may recognize that the principles described herein are equally applicable to subsea operations that employ floating or sea-based platforms and rigs, without departing from the scope of the disclosure.

As illustrated, a drilling platform 110 may support a derrick 112 having a traveling block 114 for raising and lowering drill string 116. Drill string 116 may include, but is not limited to, drill pipe and coiled tubing, as generally known to those skilled in the art. A kelly 118 may support drill string 116 as it may be lowered through a rotary table 120. A drill bit 122 may be attached to the distal end of drill string 116 and may be driven either by a downhole motor, a rotary steerable system (“RSS”), and/or via rotation of drill string 116 from surface 108. Without limitation, drill bit 122 may comprise roller cone bits, PDC bits, natural diamond bits, any hole openers, reamers, coring bits, cutting assemblies, and the like. As drill bit 122 rotates, it may create and extend wellbore 102 that penetrates various subterranean formations 106. In some examples, the rotational speed of the drill bit may be an operational parameter or an engineering parameter. A pump 124 may circulate drilling fluid through a feed pipe 126 through kelly 118, downhole through interior of drill string 116, through orifices in drill bit 122, back to surface 108 via annulus 128 surrounding drill string 116, and into a retention pit 132. In some examples, the rate at which the drilling fluid is circulated may at least partially affect the efficacy of removing drill cuttings from the wellbore or borehole. As such, in some examples, the rate at which the drilling fluid is circulated may be an engineering parameter or an operational parameter. In some examples, the drilling fluid may include drilling mud which may further include a base fluid and additives. The base fluid may be a water-based fluid, invert emulsion, or a direct emulsion. The additives may include clay (e.g., bentonite), weighting agents (e.g., barite), chemical additives (e.g., shale inhibitors, scale inhibitors, flocculants, foaming agents, stabilizers, surfactants, emulsifiers, and/or friction reducers), lost circulation material, fluid loss material, lubricants, viscosifiers, thinners, and combinations thereof. During drilling operations and wellbore construction operations, parameters associated with the drilling fluid may be measured and/or recorded by sensors and/or devices. In some non-limiting examples, the drilling fluid parameters may include fluid density (e.g., in pounds per gallon or ppg), fluid viscosity (e.g., six-speed rheology conducted at operating pressure and temperature), fluid temperature, high-weight solids content, low-weight solids content, oil-water ratio, electric stability, chlorides concentration, calcium concentration, concentration of inhibitors, low-end rheology, fluid loss, water salinity and water phase salinity, salt type and concentration, particle size distribution (e.g., of solid additives including but not limited to lost circulation material), and combinations thereof. In some examples, the properties of a drilling fluid may change as the wellbore is extended into the subterranean formation. In further examples, adjustments may be may to the drilling fluid composition in order to maintain a set of drilling fluid properties. In some examples, the drilling fluid properties may impact drilling performance. As such, monitoring and adjusting the drilling fluid properties while the drilling operation is occurring may allow for improved and/or optimized drilling performance. In some examples, large language models may be used to analyze prior well performance and identify fluid designs which may be beneficial for a drilling a given portion of a subterranean formation.

With continued reference to FIG. 1, drill string 116 may begin at wellhead 104 and may traverse wellbore 102. Drill bit 122 may be attached to a distal end of drill string 116 and may be driven, for example, either by a downhole motor and/or via rotation of drill string 116 from surface 108. In a non-limiting example, the weight of drill string 116 and bottom hole assembly may be controlled and measured while drill bit 122 is disposed within wellbore 102. In further examples, drill bit 122 may or may not be in contact with the bottom of wellbore 102. Drill bit 122 may be allowed to contact the bottom of wellbore 102 with varying amounts of weight applied to drill bit 122. The weight of drill string 116 may be measured at the surface of wellbore 102 and may be referred to as the “hook load.” The difference in the hook load when drill bit 122 is suspended just above the bottom of wellbore 102 and the hook load when drill bit 122 is in contact with the bottom of wellbore 102 may be referred to as the weight-on-bit (“WOB”). Both the hook load and the weight-on-bit may be considered operational parameters and/or engineering parameters. In some examples the hook load may be measured by a hoisting system or a hook load sensor. In some examples, the hook load is measured at the surface by a sensor disposed at the surface of drilling system 100.

Drill bit 122 may be a part of bottom hole assembly 130 at the distal end of drill string 116. In some examples, bottom hole assembly 130 may further include tools for directional drilling applications. In other examples, directional drilling tools may be disposed anywhere along the drill string assembly. In further examples, directional drilling tools may be disposed within the wellbore using wireline, electric line, or slick line. As will be appreciated by those of ordinary skill in the art, bottom hole assembly 130 may include drilling equipment and directional drilling tools including but not limited to a measurement-while drilling (MWD) and/or logging-while drilling (LWD) system, magnetometers, accelerometers, agitators, bent subs, orienting subs, mud motors, rotary steerable systems (RSS), jars, vibration reduction tools, roller reamers, pad pushers, non-magnetic drilling collars, whipstocks, push-the-bit systems, point-the-bit systems, directional steering heads and other directional drilling tools. Directional drilling tools may be disposed anywhere along the drill string assembly including at the portion distal to the drilling right which may be known as the Bottom hole assembly 130 may comprise any number of tools, transmitters, and/or receivers to perform downhole measurement operations. In some scenarios, these downhole measurements produce drilling parameters which may be used to guide the drilling operation. For example, as illustrated in FIG. 1, bottom hole assembly 130 may include a measurement assembly 134. It should be noted that measurement assembly 134 may make up at least a part of bottom hole assembly 130. Without limitation, any number of different measurement assemblies, communication assemblies, battery assemblies, and/or the like may form bottom hole assembly 130 with measurement assembly 134. Additionally, measurement assembly 134 may form bottom hole assembly 130 itself. In examples, measurement assembly 134 may comprise at least one sensor 136, which may be disposed at the surface of measurement assembly 134. It should be noted that while FIG. 1 illustrates a single sensor 136, there may be any number of sensors disposed on or within measurement assembly 134. Without limitation, sensors may be referred to as a transceiver. Further, it should be noted that there may be any number of sensors disposed along bottom hole assembly 130 at any degree from each other. In examples, sensors 136 may also include backing materials and matching layers. It should be noted that sensors 136 and assemblies housing sensors 136 may be removable and replaceable, for example, in the event of damage or failure. Herein, one or more sensors 136 may include both transmitters and receivers. In examples, one or more sensors may comprise resistivity and/or any other downhole sensors for performing resistivity, drilling parameter, and sensor data measurements. Further, one or more sensors may be performed in real time. Herein, real time may be defined as instantaneous or with computing delays.

Without limitation, bottom hole assembly 130 may be connected to and/or controlled by information handling system 131, which may be disposed on surface 108. Without limitation, information handling system 131 may be disposed down hole in bottom hole assembly 130. In addition to the sensors and measurement devices disposed on bottom hole assembly 130, information handling system 131 may be connected to sensors disposed on any other piece of equipment used in drilling system 100 including sensors disposed on the drilling platform 110, derrick 112, drill string 116, pumps 124, retention pit 132, wellhead 104, and sensors disposed within the wellbore 102 which are not connected to the drill string 116 or bottom hole assembly 130. Processing of information recorded may occur down hole and/or on surface 108. Processing occurring downhole may be transmitted to surface 108 to be recorded, observed, and/or further analyzed. Additionally, information recorded on information handling system 131 that may be disposed down hole may be stored until bottom hole assembly 130 may be brought to surface 108. In examples, information handling system 131 may communicate with bottom hole assembly 130 through a communication line (not illustrated) disposed in (or on) drill string 116. In examples, wireless communication may be used to transmit information back and forth between information handling system 131 and bottom hole assembly 130. Information handling system 131 may transmit information to bottom hole assembly 130 and may receive as well as process information recorded by bottom hole assembly 130. In examples, a downhole information handling system (not illustrated) may include, without limitation, a microprocessor or other suitable circuitry, for estimating, receiving, and processing signals from bottom hole assembly 130. Downhole information handling system (not illustrated) may further include additional components, such as memory, input/output devices, interfaces, and the like. In examples, while not illustrated, bottom hole assembly 130 may include one or more additional components, such as analog-to-digital converter, filter, and amplifier, among others, that may be used to process the measurements of bottom hole assembly 130 before they may be transmitted to surface 108. Alternatively, raw measurements from bottom hole assembly 130 may be transmitted to surface 108.

Any suitable technique may be used for transmitting signals from bottom hole assembly 130 to surface 108, including, but not limited to, wired pipe telemetry, mud-pulse telemetry, acoustic telemetry, and electromagnetic telemetry. While not illustrated, bottom hole assembly 130 may include a telemetry subassembly that may transmit telemetry data to surface 108. At surface 108, pressure sensors (not shown) may convert the pressure signal into electrical signals for a digitizer (not illustrated). The digitizer may supply a digital form of the telemetry signals to information handling system 131 via a communication link 140, which may be a wired or wireless link. The telemetry data may be analyzed and processed by information handling system 131. In some examples, information handling system 131 may be configured to update a hybrid data generator to generate an updated drilling program based on the measurements gathered from the various sensors disposed on the drilling equipment. In some examples, threshold values set for various drilling parameters, engineering parameters, operational parameters, and/or fluid parameters, which may be measured by any one or more of the sensors disposed within the drilling operation, may trigger the hybrid data generator to generate an updated drilling program. In further examples, the information handling system may be configured to update the hybrid data generator such that the drilling program is updated continuously, at set intervals, at random intervals, by manual execution as determined by personnel, when a threshold is met for any one or more parameters as described above, or combinations thereof. In some examples, manual input may be provided which may be utilized to update the hybrid data generator. In further examples the updated drilling program may be automatically implemented or may require review and approval by personnel prior to implementation.

As illustrated, communication link 140 (which may be wired or wireless, for example) may be provided that may transmit data from bottom hole assembly 130 to an information handling system 131 at surface 108. Information handling system 131 may include a personal computer 141, a video display 142, a keyboard 144 (i.e., other input devices), and/or non-transitory computer-readable media 146 (e.g., optical disks, magnetic disks) that may store code representative of the methods described herein. In addition to, or in place of processing at surface 108, processing may occur downhole. As will be discussed below, the hybrid data generator may be executed on information handling system 131, both before drilling operations commence, while drilling operations are occurring, or during periods where drilling operations are stalled, to generate an initial and/or an updated drilling program.

Information handling system 131 may include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, an information handling system 131 may be a personal computer, a network storage device, or any other suitable device and may vary in size, shape, performance, functionality, and price. Information handling system 131 may include random access memory (RAM), one or more processing resources such as a central processing unit (CPU) or hardware or software control logic, ROM, and/or other types of nonvolatile memory. Additional components of the information handling system 131 may include one or more disk drives 146, output devices 142, such as a video display, and one or more network ports for communication with external devices as well as an input device 144 (e.g., keyboard, mouse, etc.). Information handling system 131 may also include one or more buses operable to transmit communications between the various hardware components.

Alternatively, systems and methods of the present disclosure may be implemented, at least in part, with non-transitory computer-readable media. Non-transitory computer-readable media may include any instrumentality or aggregation of instrumentalities that may retain data and/or instructions for a period of time. Non-transitory computer-readable media may include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

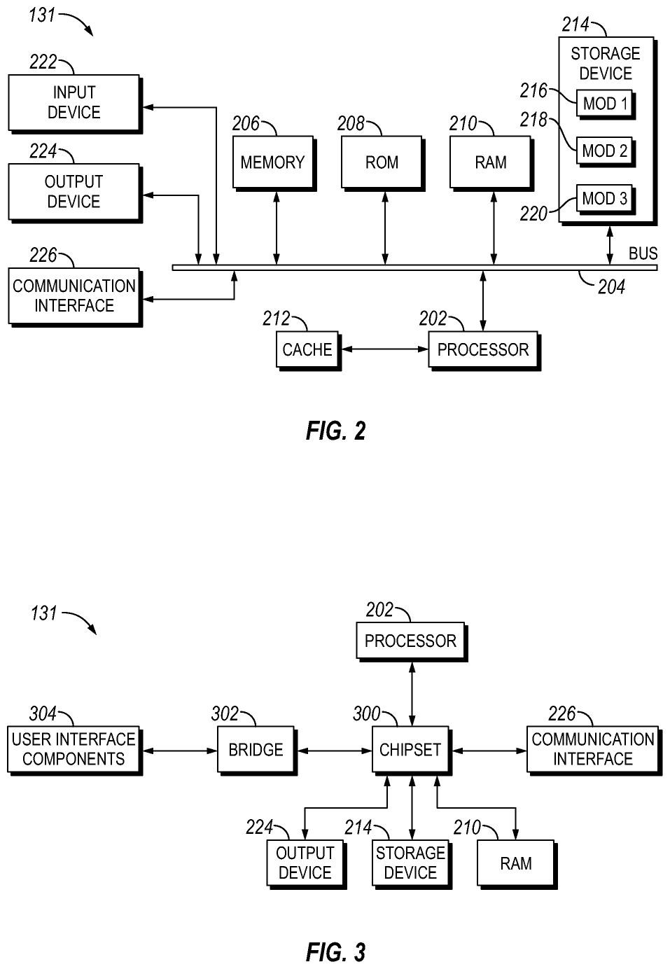

FIG. 2 illustrates an example information handling system 131 which may be employed to perform various steps, methods, and techniques disclosed herein. Persons of ordinary skill in the art will readily appreciate that other system examples are possible. As illustrated, information handling system 131 includes a processing unit (CPU or processor) 202 and a system bus 204 that couples various system components including system memory 206 such as read only memory (ROM) 208 and random-access memory (RAM) 210 to processor 202. Processors disclosed herein may all be forms of this processor 202. Information handling system 131 may include a cache 212 of high-speed memory connected directly with, in close proximity to, or integrated as part of processor 202. Information handling system 131 copies data from memory 206 and/or storage device 214 to cache 212 for quick access by processor 202. In this way, cache 212 provides a performance boost that avoids processor 202 delays while waiting for data. These and other modules may control or be configured to control processor 202 to perform various operations or actions. Other system memory 206 may be available for use as well. Memory 206 may include multiple different types of memory with different performance characteristics. It may be appreciated that the disclosure may operate on information handling system 131 with more than one processor 202 or on a group or cluster of computing devices networked together to provide greater processing capability. Processor 202 may include any general-purpose processor and a hardware module or software module, such as first module 216, second module 218, and third module 220 stored in storage device 214, configured to control processor 202 as well as a special-purpose processor where software instructions are incorporated into processor 202. Processor 202 may be a self-contained computing system, containing multiple cores or processors, a bus, memory controller, cache, etc. A multi-core processor may be symmetric or asymmetric. Processor 202 may include multiple processors, such as a system having multiple, physically separate processors in different sockets, or a system having multiple processor cores on a single physical chip. Similarly, processor 202 may include multiple distributed processors located in multiple separate computing devices but working together such as via a communications network. Multiple processors or processor cores may share resources such as memory 206 or cache 212 or may operate using independent resources. Processor 202 may include one or more state machines, an application specific integrated circuit (ASIC), or a programmable gate array (PGA) including a field PGA (FPGA).

Each individual component discussed above may be coupled to system bus 204, which may connect each and every individual component to each other. System bus 204 may be any of several types of bus structures including a memory bus or memory controller, a peripheral bus, and a local bus using any of a variety of bus architectures. A basic input/output (BIOS) stored in ROM 208 or the like, may provide the basic routine that helps to transfer information between elements within information handling system 131, such as during start-up. Information handling system 131 further includes storage devices 214 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 214 may include software modules 216, 218, and 220 for controlling processor 202. Information handling system 131 may include other hardware or software modules. Storage device 214 is connected to the system bus 204 by a drive interface. The drives and the associated computer-readable storage devices provide nonvolatile storage of computer-readable instructions, data structures, program modules and other data for information handling system 131. In one aspect, a hardware module that performs a particular function includes the software component stored in a tangible computer-readable storage device in connection with the necessary hardware components, such as processor 202, system bus 204, and so forth, to carry out a particular function. In another aspect, the system may use a processor and computer-readable storage device to store instructions which, when executed by the processor, cause the processor to perform operations, a method or other specific actions. For example, the hybrid data generator, which may include a Large Language Model or other models derived from machine learning- and deep learning algorithms, may include computational instructions which may be executed on a processor to generate an initial and/or an updated drilling program. In some examples, the deep learning algorithms may include convolutional neural networks, long short term memory networks, recurrent neural networks, generative adversarial networks, attention neural networks, zero-shot models, fine-tuned models, domain-specific models, multi-modal models, transformer architectures, radial basis function networks, multilayer perceptrons, self-organizing maps, deep belief networks, and combinations thereof. The basic components and appropriate variations may be modified depending on the type of device, such as whether information handling system 131 is a small, handheld computing device, a desktop computer, or a computer server. When processor 202 executes instructions to perform “operations”, processor 202 may perform the operations directly and/or facilitate, direct, or cooperate with another device or component to perform the operations.

As illustrated, information handling system 131 employs storage device 214, which may be a hard disk or other types of computer-readable storage devices which may store data that are accessible by a computer, such as magnetic cassettes, flash memory cards, digital versatile disks (DVDs), cartridges, random access memories (RAMs) 210, read only memory (ROM) 208, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 131, an input device 222 represents any number of input mechanisms, such as a microphone for speech, a touch-sensitive screen for gesture or graphical input, keyboard, mouse, motion input, speech and so forth. An output device 224 may also be one or more of a number of output mechanisms known to those of skill in the art. In some instances, multimodal systems enable a user to provide multiple types of input to communicate with information handling system 131. Communications interface 226 generally governs and manages the user input and system output. There is no restriction on operating on any particular hardware arrangement and therefore the basic hardware depicted may easily be substituted for improved hardware or firmware arrangements as they are developed.

As illustrated, each individual component describe above is depicted and disclosed as individual functional blocks. The functions these blocks represent may be provided through the use of either shared or dedicated hardware, including, but not limited to, hardware capable of executing software and hardware, such as a processor 202, that is purpose-built to operate as an equivalent to software executing on a general-purpose processor. For example, the functions of one or more processors presented in FIG. 2 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 208 for storing software performing the operations described below, and random-access memory (RAM) 210 for storing results. Very large-scale integration (VLSI) hardware examples, as well as custom VLSI circuitry in combination with a general-purpose DSP circuit, may also be provided.

FIG. 3 illustrates an example information handling system 131 having a chipset architecture that may be used in executing the described method and generating and displaying a graphical user interface (GUI). Information handling system 131 is an example of computer hardware, software, and firmware that may be used to implement the disclosed technology. Information handling system 131 may include a processor 202, representative of any number of physically and/or logically distinct resources capable of executing software, firmware, and hardware configured to perform identified computations. Processor 202 may communicate with a chipset 300 that may control input to and output from processor 202. In this example, chipset 300 outputs information to output device 224, such as a display, and may read and write information to storage device 214, which may include, for example, magnetic media, and solid-state media. Chipset 300 may also read data from and write data to RAM 210. A bridge 302 for interfacing with a variety of user interface components 304 may be provided for interfacing with chipset 300. Such user interface components 304 may include a keyboard, a microphone, touch detection and processing circuitry, a pointing device, such as a mouse, and so on. In general, inputs to information handling system 131 may come from any of a variety of sources including machine generated and/or human generated.

Chipset 300 may also interface with one or more communication interfaces 226 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 202 analyzing data stored in storage device 214 or RAM 210. Further, information handling system 131 may receive one or more inputs from a user via user interface components 304 and execute appropriate functions, such as browsing functions by interpreting these inputs using processor 202.

In examples, information handling system 131 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

During drilling operations, information handling system 131 may process different types of the real time data originated from varied sampling rates and various sources, such as diagnostics data, sensor measurements, operations data, and/or the like. These one or more measurements from wellbore 102, BHA 130, measurement assembly 134, and one or more sensors 136 may allow for information handling system 131 to perform real-time health assessment of the drilling operation. In some examples, the foregoing one or more measurements may be utilized to generate an updated drilling program when the one or more measurements are supplied to the hybrid data generator. Drilling tools and equipment may further comprise a variety of sensors which may be able to provide one or more real-time measurements and data relevant to steering the wellbore in adherence to a well plan. In some examples this drilling equipment may include drilling rigs, top drives, drilling tubulars, mud motors, gyroscopes, accelerometers, magnetometers, bent housing subs, directional steering heads, rotary steerable systems (“RSS”), whipstocks, push-the-bit systems, point-the-bit systems, and other directional drilling tools. In the context of drilling operations, “real-time,” may be construed as monitoring, gathering, assessing, and/or utilizing data contemporaneously with the execution of the drilling operation. Real-time operations may further comprise modifying the initial design or execution of the planned operation in order to modify a well plan of a drilling operation. In some examples, the modifications to the drilling operation may occur through automated or semi-automated processes. An example of an automated drilling process may include relaying or downlinking a set of operational commands (control commands) to an RSS in order to modify a drilling operation to achieve a certain objective. In other examples, operational commands (control commands), which may be derived from an initial or an updated drilling program may be automatically relayed to the top drive. In other examples, the operational commands (control commands) may be relayed to the rig personnel for review prior to implementation. In some examples, one or more drilling objectives and operational features may be incorporated into the drilling operation through the utilization of a cost function. In further examples, the cost function may be optimized for one or more operational features including but not limited to maximizing rate of penetration, maximizing hole cleaning, maximizing hole stability, operational safety, minimizing total drilling cost, minimizing operational time per hole section, minimizing cost per hole section, and combinations thereof.

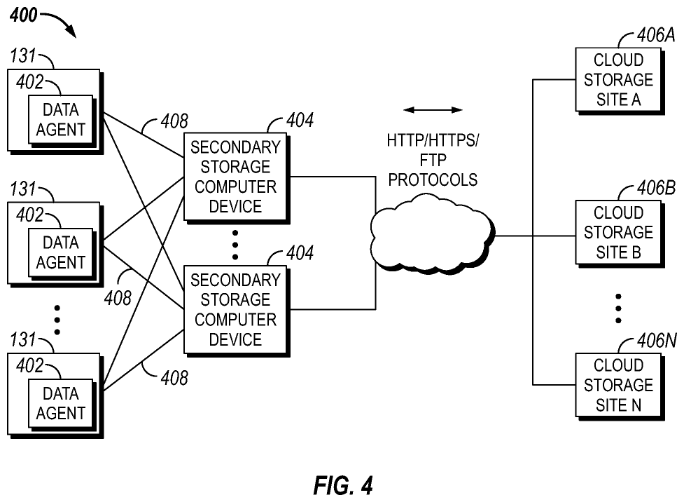

FIG. 4 illustrates an example of one arrangement of resources in a computing network 400 that may employ the processes and techniques described herein, although many others are of course possible. As noted above, an information handling system 131, as part of their function, may utilize data, which includes files, directories, metadata (e.g., access control list (ACLS) creation/edit dates associated with the data, etc.), and other data objects. The data on the information handling system 131 is typically a primary copy (e.g., a production copy). During a copy, backup, archive or other storage operation, information handling system 131 may send a copy of some data objects (or some components thereof) to a secondary storage computing device 404 by utilizing one or more data agents 402.

A data agent 402 may be a desktop application, website application, or any software-based application that is run on information handling system 131. As illustrated, information handling system 131 may be disposed at any rig site (e.g., referring to FIG. 1) or repair and manufacturing center. The data agent may communicate with a secondary storage computing device 404 using communication protocol 408 in a wired or wireless system. The communication protocol 408 may function and operate as an input to a website application. In the website application, field data related to pre- and post-operations, generated DTCs, notes, and the like may be uploaded. Additionally, information handling system 131 may utilize communication protocol 408 to access processed measurements, operations with similar DTCs, troubleshooting findings, historical run data, and/or the like. This information is accessed from secondary storage computing device 404 by data agent 402, which is loaded on information handling system 131.

Secondary storage computing device 404 may operate and function to create secondary copies of primary data objects (or some components thereof) in various cloud storage sites 406A-N. Additionally, secondary storage computing device 404 may run determinative algorithms on data uploaded from one or more information handling systems 131, discussed further below. Communications between the secondary storage computing devices 404 and cloud storage sites 406A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 406A-N, the secondary storage computing device 404 may also perform local content indexing and/or local object-level, sub-object-level or block-level deduplication when performing storage operations involving various cloud storage sites 406A-N. Cloud storage sites 406A-N may further record and maintain DTC code logs for each downhole operation or run, map DTC codes, store repair and maintenance data, store operational data, and/or provide outputs from determinative algorithms and or models that are located in cloud storage sites 406A-N. In a non-limiting example, this type of network may be utilized as a platform to store, backup, analyze, import, and perform extract, transform and load (“ETL”) processes to the data gathered during a drilling operation. In further examples, this type of network may be utilized to execute a hybrid data generator to generate an initial and/or an updated drilling program.

As previously mentioned, the hybrid data generator may include a stack of models which are run in series, in parallel, or combinations thereof to produce a drilling program. The development of drilling programs, whether executed using a hybrid data generator or using traditional methods, may require the analysis of text-based data. Additionally, the drilling programs (e.g., an output from a hybrid data generator) themselves may include text-based data. In some examples, Large Language Models may be proficient in analyzing input provided in the form of text, while providing an output in the form of text. As such, a Large Language Model may be included in the stack of models which form the hybrid data generator. In some examples, Large Language Models may be trained on large amounts of text data including but not limited to books, technical papers, articles, previous drilling reports, web-based content, emails, technical presentations, and various other forms of text-based data. In some examples, a Large Language Model algorithm may include a deep learning architecture which may be referred to as a transformer architecture. The transformer architecture may allow for a language model to perform natural language processing tasks in a fashion that mimics human-like responses. In some examples, tasks performed by natural language processing may include text-based content creation and generation, next-word predictions in sentence construction, summarization, machine translation, application (e.g., computer-based “apps”) generation, and/or answering text-based questions with text-based responses. In further examples, large language models supported by transformer architecture may be able to learn the patterns and structures of language.

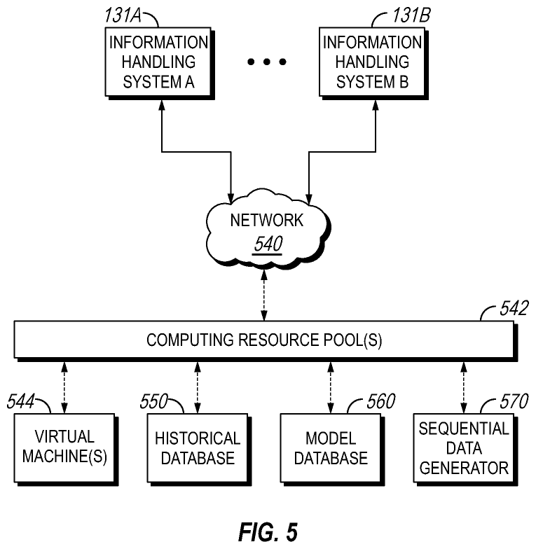

FIG. 5 is a diagram of an example system with multiple information handling systems, connected via a network, and used to form computing resource pools. While a specific configuration may be shown, other configurations may be used without departing from the disclosed embodiment. Accordingly, embodiments disclosed herein should not be limited to the configuration of devices and/or components shown.

In any embodiment, a system may include one or more information handling system(s) (e.g., information handling system A 200A, information handling system B 200B), network 540, computing resource pool(s) 542, virtual machine(s) 544, historical database 550, model database 560, and sequential data generator 570. Each of these components is described below.

Network 540 may be a collection of connected network devices (not shown) that allow for the communication of data from one network device to other network devices, or the sharing of resources among network devices. Non-limiting examples of network 540 include a local area network (LAN), a wide area network (WAN) (e.g., the Internet), a mobile network, any combination thereof, or any other type of network that allows for the communication of data and sharing of resources among network devices and/or information handling systems 200 operatively connected to network 540. One of ordinary skill in the art, having the benefit of this detailed description, would appreciate that a network may be a collection of operatively connected computing devices that enables communication between those computing devices.

Computing resource pool(s) 542 are organized clusters of virtualized resources of the components, or subcomponents, of one or more information handling systems 200. Non-limiting examples of a computing resource include processor(s) 202, a processor thread, any range of memory 206, any blocks on storage device(s) 214, input device(s) 222, output device(s) 224, communication interface(s) 226, and any peripheral device components of sub-components thereof (e.g., a graphics processing unit (GPU), data processing unit (DPU), NIC, etc.). An orchestrator (not shown) may track, monitor, aggregate, computing resources together and present those resources as a “pool” of computing resources (i.e., computing resources pool(s) 542) based on a shared property. As a non-limiting example, memory 206 disposed across six information handling systems 200 may be “pooled” together and presented as a single “memory pool” (in computing resource pool(s) 542). Similarly, as another non-limiting example, GPUs installed in three independent information handling systems 200 may be “pooled” into a single “GPU pool” (in computing resource pool(s) 542). As a third non-limiting example, storage device(s) 214 disposed within a single information handling system 200 may be presented as a “storage pool” (in computing resource pool(s) 542). In turn, the orchestrator may assign (e.g., allocate) portions of one or more computing resources pool(s) 542 to software (e.g., virtual machine(s) 544, sequential data generator 570) and virtual storage volume(s) (e.g., network attached storage (NAS), historical database 550, model database 560).

As used herein, “software” means any set of computer instructions, code, and/or algorithms that are used by information handling system 200 to perform one or more specific task(s), function(s), or process(es). Information handling system 200 may execute software by reading data from memory 206 and/or storage device(s) 214, processing that data via processor 202, and writing processed data to memory 206 and/or storage device(s) 214. Multiple software instances may execute on a single information handling system 200 simultaneously. Further, in any embodiment, a single software instance may utilize resources from two or more information handling systems 200 simultaneously (e.g., via computing resource pool(s) 542) and may move between information handling systems 200, as instructed (e.g., by an orchestrator).

A virtual storage volume (e.g., historical database 550, model database 560) may be a virtual space where data may be stored. A virtual storage volume may use any suitable means of underlying storage device(s) 214 and/or memory 206 for storing data (e.g., a storage pool and/or memory pool available in computing resource pool(s) 542). A virtual storage volume may be managed by a virtual machine 544 that handles the access (reads/writes), filesystem, redundancy, and addressability of the data stored therein.

Virtual machine 544 may be software, executing on one or more information handling system(s) 200, that provides a virtual environment in which other software (e.g., a program, a process, an application, etc.) may execute. In any embodiment, virtual machine 544 may be created by a virtual machine manager (e.g., a “hypervisor”) that allocates some portion of computing resources (e.g., in one or more computing resource pool(s) 542) for virtual machine 544 to execute. The computing resources allocated to virtual machine 544 may be aggregated from one or more information handling system(s) 200 and presented as unified “virtual” resources within virtual machine 544 (e.g., virtual processor(s), virtual memory, virtual storage, virtual peripheral device(s), etc.). As computing resource pool(s) 542 are used to generate virtual machine 544, the underlying hardware storing, executing, and processing the operations (of virtual machine 544) may disposed in any number of information handling system(s) 200.

In any embodiment, virtual machine 544 may be created specifically for using one or more computing resource pool(s) 542 related to machine learning, deep learning, and/or artificial intelligence (e.g., from one or more processor(s) 202). Such virtual machine 544 may allow for the “offline” private training of one or more data model(s) (e.g., in model database 560) without exposing data in historical database 550 to any third party.

Model database 560 may be a data structure (i.e., a collection of data) that includes information about previous drilling projects. Model database 560 may take the form of a virtual storage volume (e.g., using a “storage pool” of the computing resource pool(s) 542) and/or model database 560 may be data stored locally on a single information handling system 200 (e.g., as files in a directory). Sequential data generator 570 may be software, executing on one or more information handling system(s) 200 and/or in one or more virtual machine(s) 544, that processes input data to generate output data, using one or more data models.

Historical database 550 may be a data structure (i.e., a collection of data) that includes information about previous drilling projects. Historical database 550 may take the form of a virtual storage volume (e.g., using a “storage pool” of the computing resource pool(s) 542) and/or historical database 550 may be data stored locally on a single information handling system 200 (e.g., as files in a directory). Further, historical database 550 may comprise any information available to a geosteerer. Historical database 550 may be utilized in workflows below.

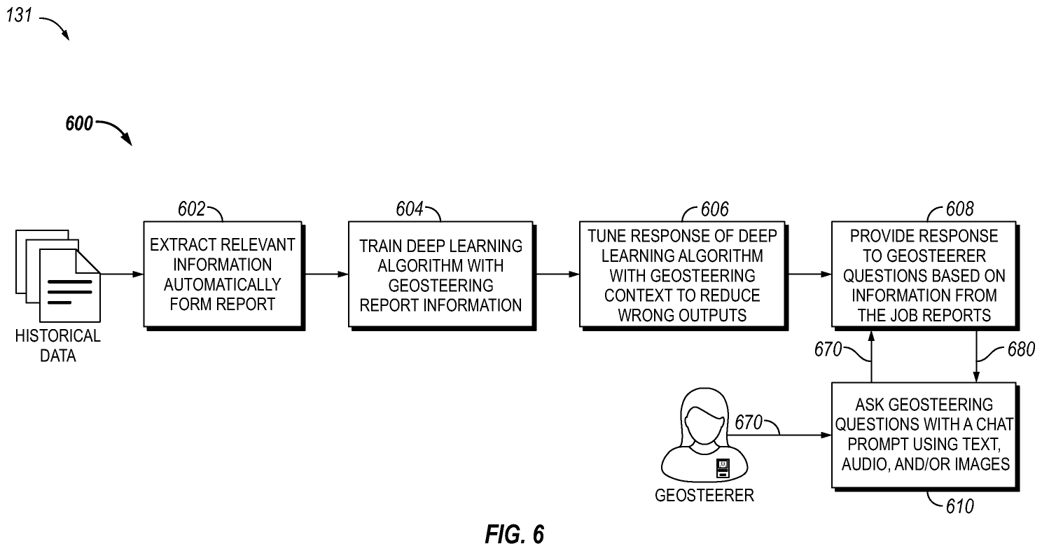

FIG. 6 illustrates AI assistant co-pilot workflow 600. In examples, AI assistant co-pilot workflow 600 may be processed at least in part on information handling system 131 (e.g., referring to FIG. 1). Workflow 600 may begin with block 602. In block 602, relevant information from historical data may be extracted. As illustrated in FIG. 6, historical data may be input into block 602. In examples, historical data may comprise previous logging data from the same wellbore 102 (e.g., referring to FIG. 1), not the same wellbore 102, but within the same formation 106. In addition, historical data may further comprise information about formation 106 recorded by the same log or a different log, information about a formation adjacent or in proximity to formation 106 and/or any other downhole information available to a geosteerer, which is relevant to wellbore 102 or formation 106. Herein, a geosteerer may be an employee located at drill site or in a remote location. Additionally, a geosteerer may be an autonomous geosteering service or process. relevant information from historical data may be extracted to form a geosteering report information. In block 604, a deep learning algorithm may be trained with the steering report information and extracted data from block 602. The deep learning model may be trained with any method comprising reinforcement learning, supervised learning, unsupervised learning, deep learning, linear regression, and or the like. Herein, deep learning model may be interchangeable with a machine learning model. In examples, any deep learning algorithm may be utilized and trained with extracted data from block 602. In block 606, the trained deep learning algorithm from block 604 may be tuned with geosteering context to reduce wrong output. For example, a geosteerer may rate the quality of an output of the deep learning algorithm from block 604 or an answer 680. Herein question 670 may be an input to trained deep learning algorithm from block 604 or block 606. For example, question 670 may comprise any number of drilling parameters, drilling operation suggestions, tool orientation, formation evaluation, or current and modifications to a well plan of the wellbore. Similarly, answer 680 may be an output to trained deep learning algorithm from block 604 or block 606. For example, answer 680 comprises suggested drilling parameters, suggested drilling operation, current tool orientation, or answers about the formation, or current and modifications to the well plan. Further, upon rating the output, the goesteerer may tune any parameter, hyper parameter, function, and/or architecture of the trained deep learning algorithm from block 604 to produce a tuned deep learning algorithm.

The product of block 606 from the tuned deep learning algorithm from block 606 may be input into block 608. In block 608, answers 680 to questions 670 may utilize trained and tuned ML algorithm from block 606. In block 610 questions 670 may be input into block 608 for tuned deep learning model and answers 680 may be received from block 608 from the tuned deep learning model, as discussed above. Question 670 may inquire about any number of drilling parameters, drilling operation suggestions, tool orientation, formation evaluation, or current and modifications to the well plan. Answers 680 may be one or more solutions to the question. Further, wherein answers 680 may comprise suggested drilling parameters, suggested drilling operation, current tool orientation, or answers about the formation, or current and modifications to the well plan.

In examples, block 610 may comprise one or more interfaces operating at the same or different times. For example, interfaces such as screens with keyboards, audio interfaces, web link-based services, information handling system 131 and/or the like. Further, answers 680 may prompt a geosteerer or automatically adjust drilling operations. This may comprise any form of steering or stopping drill bit 122. In further examples, with answers 680, a geosteerer may tune deep learning algorithm, similar to block 606. FIG. 6 illustrates a workflow for an AI assistant, however additional component may be added comprising a customer interface.

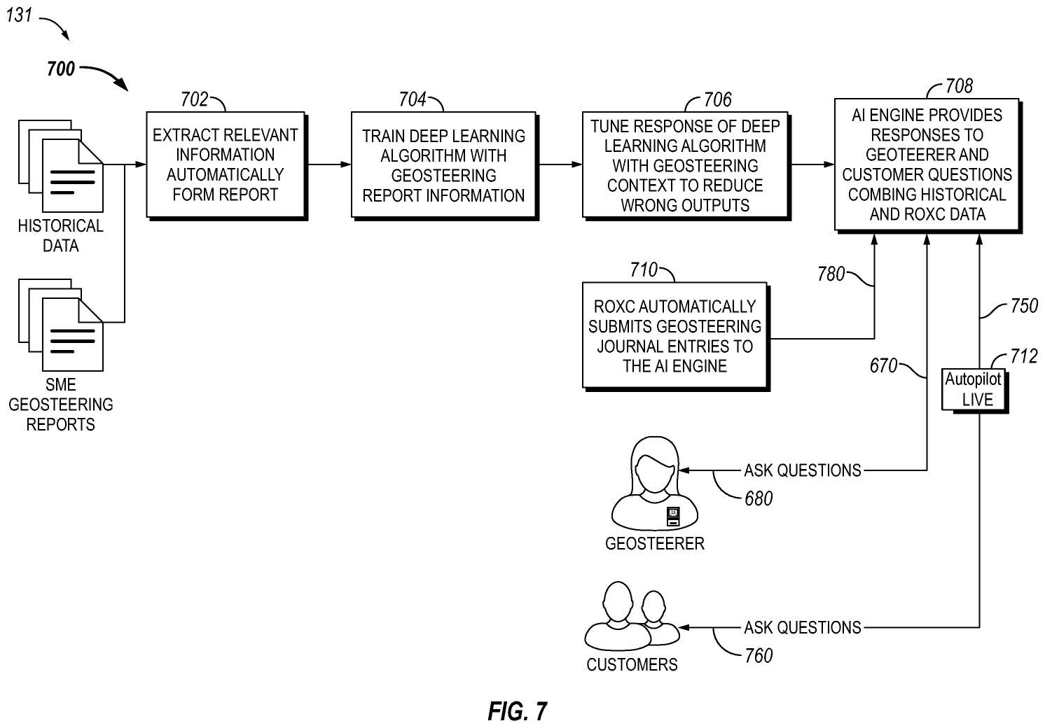

FIG. 7 illustrates an artificial co-pilot workflow 700. In examples, artificial co-pilot workflow 700 may be processed at least in part on information handling system 131 (e.g., referring to FIG. 1). In block 702, relevant information from historical data may be extracted. As illustrated in FIG. 7, historical data may be input into block 702. In examples, historical data may comprise previous logging data from the same or different wells, information about the formation recorded by the same log or a different log, and/or other downhole information, available to a geosteerer. A product of all relevant information extracted may form a geosteering report information. Additionally, geosteerers may utilize internal geosteering reports such as previous measurements. In examples, internal geosteering reports are confidential data owned by the geosteerer. In block 704, a deep learning algorithm may be trained with the steering report information and extracted data from block 702. In examples, any deep learning algorithm may be utilized and trained with extracted data from block 702. In block 706, trained deep learning algorithm from block 704 may be tuned with geosteering context to reduce wrong output. For example, a geosteerer may rate the quality of an output of the deep learning algorithm from block 704. Further, upon rating the output, the goesteerer may tune any parameter, hyper parameter, function, or architecture of the trained deep learning algorithm from block 704 to produce a tuned deep learning algorithm.

In block 708, answers 680 to questions 670 may be provided, utilizing trained and tuned ML algorithm from block 706, similar to as discussed above. Additionally, in block 708, tuned deep learning algorithm from block 706 may receive customer questions 750 from customers and customer answers 760. In examples, customer questions 750 and customer answers 760 may be received and transmitted via autopilot live 712 and may be more restricted than answers 680 and questions 670. For example, customer questions 750 and customer answers 760 may not comprise internal company information directly in a report, despite utilizing such information in prior blocks. Further, autopilot live 712 may operate for customers on the same interfaces as answers 680 (e.g., referring to FIG. 6) and questions 670. In block 710, may catalog geosteering decisions and generate them into a drilling report stored. Further, the report may be transmitted to tuned deep learning algorithm from block 706. Additionally, real time measurements 780 may be input into the tuned deep learning model in block 708. Further, real time measurements 780 may be recorded with geosteering operations in the drilling report. Said real time measurements 780 may be from one or more sensors 136 (e.g., referring to FIG. 1) on the bottom hole assembly 130. With answers 680 and real time measurements 780, a geosteerer may make drilling decisions.

Improvements over the current art allow enhancing a trained ML model. For example, a ML model may be tuned in the context of geosteering. The tuned ML model may then be used by a geosteerer to ask questions and receive answers. Additionally, the ML model may be tuned with real time measurements. In effect a standard ML model may be tuned with real time measurements as well as in the context of geosteering to provide a state of the art AI assistant.

The systems and methods may include any of the various features disclosed herein, including one or more of the following statements. The systems and methods may include any of the various features disclosed herein, including one or more of the following statements.

Statement 1. A method comprising: disposing a bottom hole assembly (BHA) into a wellbore, wherein the BHA comprises a measurement assembly; acquiring one or more measurements with the measurement assembly; acquiring historical data from the wellbore; extracting relevant information from the historical data; training a machine learning (ML) model with the relevant information to form a trained ML model; and providing an answer to a question utilizing the trained ML model.

Statement 2. The method of statement 1, further comprising tuning the trained ML model with a geosteering context to form a tuned ML model.

Statement 3. The method of statement 2, wherein the tuning the geosteering context comprises rating a quality of an output of the trained ML model.

Statement 4. The method of statement 3, further comprising tuning parameter, hyper parameter, function, and/or architecture of the trained ML model based at least on the quality of an output of the trained ML model.

Statement 5. The method of statements 1-4, wherein historical data comprises previous logging data from the wellbore, a different wellbore within the same formation as the wellbore, information from the same formation, or information about an adjacent formation.

Statement 6. The method of statements 1-5, wherein historical data comprises internal geosteering reports.

Statement 7. The method of statement 2-6, wherein a question is an input to the tuned ML model.

Statement 8. The method of statement 7, wherein the question asks any number of drilling parameters, drilling operation suggestions, tool orientation, formation evaluation, or current and modifications to a well plan of the wellbore.

Statement 9. The method of statement 8, wherein the answer is one or more solutions to the question.

Statement 10. The method of statement 9, wherein the answer comprises suggested drilling parameters, suggested drilling operation, current tool orientation, or answers about the formation, or current and modifications to the well plan.

Statement 11. The method of statement 10, further comprising providing a geosteerer an interface to provide a question and receive an answer, wherein the interface comprises screens with keyboards, audio interfaces.

Statement 12. The method of statements 1-11, wherein the one or more measurements are performed in real time and comprise resistivity, drilling parameter, and sensor data measurements.

Statement 13. The method of statements 1-12, further comprising processing a customer question and customer answer.

Statement 14. A system comprising: a bottom hole assembly (BHA) disposed in a wellbore, wherein the BHA comprises a measurement assembly configured to acquire one or more measurements; and an information handling system configured to: acquire historical data from the wellbore; extract relevant information from the historical data; train a machine learning (ML) model with the relevant information to form a trained ML model; and provide an answer to a question utilizing the trained ML model.

Statement 15. The system of statement 14, wherein the information handling system is further configured to tune the trained ML model with a geosteering context.

Statement 16. The system of statement 15, wherein the tuning the geosteering context comprises rating a quality of an output of the trained ML model.

Statement 17. The system of statement 16, wherein the information handling system is further configured to tune parameter, hyper parameter, function, and/or architecture of the trained ML model based at least on the quality of an output of the trained ML model.

Statement 18. The system of statements 14-17, wherein historical data comprises previous logging data from the wellbore, a different wellbore within the same formation as the wellbore, information from the same formation, or information about an adjacent formation.

Statement 19. The system of statements 14-18, wherein historical data comprises internal geosteering reports.

Statement 20. The system of statements 14-19, wherein the one or more measurements are performed in real time and comprise resistivity, drilling parameter, and sensor data measurements.

Although the present disclosure and its advantages have been described in detail, it should be understood that various changes, substitutions and alterations may be made herein without departing from the spirit and scope of the disclosure as defined by the appended claims. The preceding description provides various examples of the systems and methods of use disclosed herein which may contain different method steps and alternative combinations of components. It should be understood that, although individual examples may be discussed herein, the present disclosure covers all combinations of the disclosed examples, including, without limitation, the different component combinations, method step combinations, and properties of the system. It should be understood that the compositions and methods are described in terms of “comprising,” “containing,” or “including” various components or steps, the compositions and methods may also “consist essentially of” or “consist of” the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present examples are well adapted to attain the ends and advantages mentioned as well as those that are inherent therein. The particular examples disclosed above are illustrative only and may be modified and practiced in different but equivalent manners apparent to those skilled in the art having the benefit of the teachings herein. Although individual examples are discussed, the disclosure covers all combinations of all of the examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative examples disclosed above may be altered or modified and all such variations are considered within the scope and spirit of those examples. If there is any conflict in the usages of a word or term in this specification and one or more patent(s) or other documents that may be incorporated herein by reference, the definitions that are consistent with this specification should be adopted.

What is claimed is:

1. A method comprising:
disposing a bottom hole assembly (BHA) into a wellbore, wherein the BHA comprises a measurement assembly;
acquiring one or more measurements with the measurement assembly;
acquiring historical data from the wellbore;
extracting relevant information from the historical data;
training a machine learning (ML) model with the relevant information to form a trained ML model; and
providing an answer to a question utilizing the trained ML model.

2. The method of claim 1, further comprising tuning the trained ML model with a geosteering context to form a tuned ML model.

3. The method of claim 2, wherein the tuning the geosteering context comprises rating a quality of an output of the trained ML model.

4. The method of claim 3, further comprising tuning parameter, hyper parameter, function, and/or architecture of the trained ML model based at least on the quality of an output of the trained ML model.

5. The method of claim 1, wherein historical data comprises previous logging data from the wellbore, a different wellbore within the same formation as the wellbore, information from the same formation, or information about an adjacent formation.

6. The method of claim 1, wherein historical data comprises internal geosteering reports.

7. The method of claim 2, wherein a question is an input to the tuned ML model.

8. The method of claim 7, wherein the question asks any number of drilling parameters, drilling operation suggestions, tool orientation, formation evaluation, or current and modifications to a well plan of the wellbore.

9. The method of claim 8, wherein the answer is one or more solutions to the question.

10. The method of claim 9, wherein the answer comprises suggested drilling parameters, suggested drilling operation, current tool orientation, or answers about the formation, or current and modifications to the well plan.

11. The method of claim 10, further comprising providing a geosteerer an interface to provide a question and receive an answer, wherein the interface comprises screens with keyboards, audio interfaces.

12. The method of claim 1, wherein the one or more measurements are performed in real time and comprise resistivity, drilling parameter, and sensor data measurements.

13. The method of claim 1, further comprising processing a customer question and customer answer.

14. A system comprising:
a bottom hole assembly (BHA) disposed in a wellbore, wherein the BHA comprises a measurement assembly configured to acquire one or more measurements; and
an information handling system configured to:
acquire historical data from the wellbore;
extract relevant information from the historical data;
train a machine learning (ML) model with the relevant information to form a trained ML model; and
provide an answer to a question utilizing the trained ML model.

15. The system of claim 14, wherein the information handling system is further configured to tune the trained ML model with a geosteering context.

16. The system of claim 15, wherein the tuning the geosteering context comprises rating a quality of an output of the trained ML model.

17. The system of claim 16, wherein the information handling system is further configured to tune parameter, hyper parameter, function, and/or architecture of the trained ML model based at least on the quality of an output of the trained ML model.

18. The system of claim 14, wherein historical data comprises previous logging data from the wellbore, a different wellbore within the same formation as the wellbore, information from the same formation, or information about an adjacent formation.

19. The system of claim 14, wherein historical data comprises internal geosteering reports.

20. The system of claim 14, wherein the one or more measurements are performed in real time and comprise resistivity, drilling parameter, and sensor data measurements.
